(19) United States
(12) Patent Application Publication
(10) Pub. No.: US 2003/0050852 A1
(43) Pub. Date: Mar. 13, 2003

(54) Purchase order tracking system and method for providing online purchase order manipulation progress report to customer

(76) Inventors: Yi-Ming Liao, Taipei (TW); Cheng-Yu Chen, Taipei (TW); Yun-Chi Lee, Taipei (TW)

Correspondence Address: SAWYER LAW GROUP LLP, Embarcadero Corporate Center, Suite 406, 2465 East Bayshore Road, Palo Alto, CA, 94303, US

(21) Appl. No.: 10/044,116

(22) Filed: Oct. 19, 2001

(30) Foreign Application Priority Data
Sep. 12, 2001 (TW) 90122544

(51) Int. Cl. G06F 17/60

(52) U.S. Cl. 705/26

(57) ABSTRACT

A purchase order tracking system and method is proposed, which allows a customer who have issued an electronic purchase order, such as EDI 850, to a manufacturer to track the progress of the manipulation of the purchase order by the manufacturer. The proposed purchase order tracking system and method is characterized by the provision of an on-line purchase order manipulation progress report for each received EDI-850 electronic purchase order to record related data at the completion of each stage of the purchase order manipulation. The purchase order manipulation progress report is then downloaded into a Web-linked database so as to allow the customer to gain access to the purchase order manipulation progress report by linking via Internet to the Web server and view the contents of the purchase order manipulation progress report through a Web browser program. This allows the customer to track the progress of the purchase order manipulation by the manufacturer more efficiently and reliably in real time via Internet.

### BACKGROUND OF THE INVENTION

1. Field of the Invention

This invention relates to information technology, and more particularly, to a purchase order tracking system and method, which allows a customer who has issued an electronic purchase order, such as EDI 850, to a manufacturer to track the progress of the manipulation of the purchase order by the manufacturer.

2. Description of Related Art

In the manufacture industry, such as the CEM (Contract Electronics Manufacture) industry, after a customer has issued issues a purchase order to a manufacturer, the customer has to wait for a certain period, typically several months, until the shipment of the ordered products. At the manufacturer site, the manipulation of the purchase order includes a number of stages, including, for example, purchase order acknowledgement, production scheduling, delivery, customs/exportation, and shipment notification, which might take several months to complete.

During this waiting period, the customer may want to track the progress of the purchase order manipulation by the manufacturer. Conventionally, the tracking of the progress of the purchase order manipulation by the manufacturer is achieved by phone or fax inquiry to the manufacturer. One drawback to this practice, however, is that it is quite laborious, inefficient, and unreliable, and can be responded by the manufacturer only during their office hours, which is quite inconvenient for the customer.

### SUMMARY OF THE INVENTION

It is therefore an objective of this invention to provide a purchase order tracking system and method which allows a customer who has issued an electronic purchase order to a manufacturer to track the progress of the manipulation of the purchase order at the manufacturer site conveniently via a network system, such as Internet.

It is another objective of this invention to provide a purchase order tracking system and method which allows a manufacturer to provide online purchase order manipulation progress report to a customer who has issued an electronic purchase order to the manufacturer.

The purchase order tracking system and method according to the invention is characterized by the provision of an on-line purchase order manipulation progress report for each received EDI-850 electronic purchase order to record related data at the completion of each stage of the purchase order manipulation. The purchase order manipulation progress report is then downloaded into a Web-linked database so as to allow the customer to gain access to the purchase order manipulation progress report by linking via Internet to the Web server and view the contents of the purchase order manipulation progress report through a Web browser program.

Compared to the prior art, the purchase order tracking system and method of the invention allows the customer who have issued an electronic purchase order to the manufacturer to track the progress of the purchase order manipulation by the manufacturer more efficiently and reliably in real time via Internet. The invention is therefore more advantageous to use than the prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the fundamental system architecture of the purchase order tracking system according to the invention; and

FIG. 2 is a flow diagram showing the procedural steps performed by the purchase order tracking system and method according to the invention.

### DETAILED DESCRIPTION OF PREFERRED EMBODIMENTS

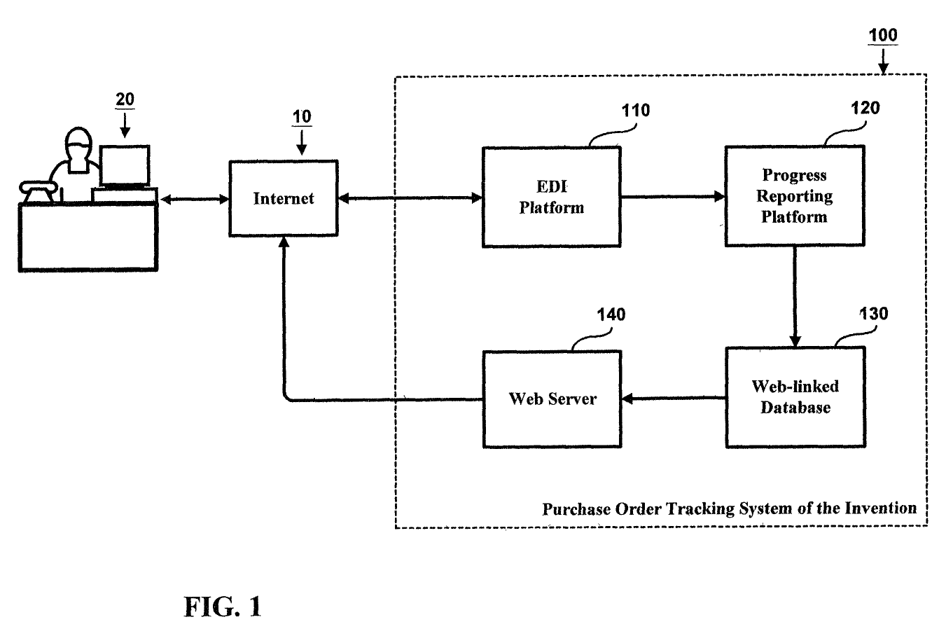

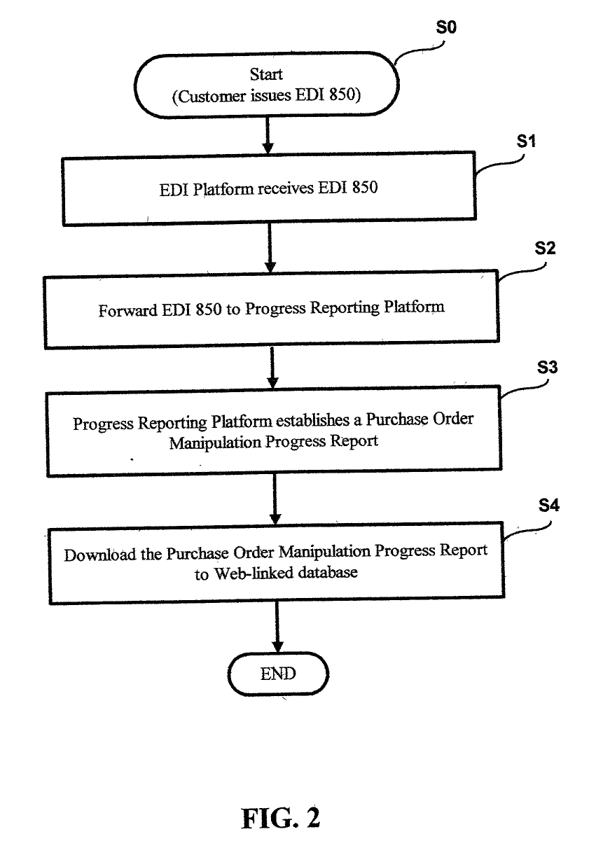

The purchase order tracking system and method according to the invention is disclosed in full details in the following with reference to FIG. 1 and FIG. 2.

Referring first to FIG. 1, the purchase order tracking system of the invention is here shown as the part enclosed in the dashed box labeled with the reference numeral 100. In practical use, the purchase order tracking system of the invention 100 can be installed at a manufacture site to allow the manufacturer to provide an on-line purchase order manipulation progress report to the customer.

The purchase order tracking system of the invention 100 is externally linked to a network system, such as Internet 10, and can be internally integrated as a part of the electronic commerce information system (not shown) at the manufacture site for both sites to exchange business transaction data via the Internet 10.

The purchase order tracking system of the invention 100 comprises: (a) an EDI platform 110; (b) a progress reporting platform 120; and (c) a network-linked database, such as a Web-linked database 130; and (d) a network server, such as a Web server 140.

The EDI platform 110 is compliant with standard EDI (Electronic Data Interchange) protocol for sending and receiving EDI-compliant business transaction data via the Internet 10. The customer 20 can, for example, send an EDI-850 electronic purchase order via the Internet 10 to the EDI platform 110. The received EDI-850 electronic purchase order is then forwarded to the progress reporting platform 120 as well as to related departments, such as production department and customer service department (not shown). Since the EDI standard is well-known in the information industry, description thereof will not be further detailed

The progress reporting platform 120, upon receiving the EDI-850 electronic purchase order, will establish a new purchase order manipulation progress report, which will be used to provide related data at each stage in the progress of the manipulation of the purchase order. The data shown in the purchase order manipulation progress report includes, for example, purchase order acknowledgement, production scheduling, delivery, customs/exportation, and shipment notification. At the completion of each stage of purchase order manipulation, the related data will be promptly forwarded to the progress reporting platform 120 and recorded into the purchase order manipulation progress report.

The Web-linked database 130 is used to store the purchase order manipulation progress report generated by the progress reporting platform 120. At the completion of each stage of purchase order manipulation, the progress reporting platform 120 will promptly update related data into the purchase order manipulation progress report and download it into the Web-linked database 130 for immediate online access.

The Web server 140 is externally linked to Internet 10 and internally linked to the Web-linked database 130, for serving up the purchase order manipulation progress report stored in the Web-linked database 130 via Internet 10 to the customer 20; i.e., the customer 20 can gain access to the purchase order manipulation progress report stored in the Web-linked database 130 by linking via the Internet 10 to the Web server 140 and then view the contents of the purchase order manipulation progress report through a Web browser program, such as Microsoft Internet Explorer or Netscape Navigator.

FIG. 2 is a flow diagram showing the procedural steps performed by the purchase order tracking system of the invention 100.

In the flow diagram of FIG. 2, the initial step S0 shows that the purchase order tracking system of the invention 100 is started when a customer 20 issues an electronic purchase order, such as EDI-850, via the Internet 10 to the EDI platform 110. Upon receiving the EDI-850 electronic purchase order, the purchase order tracking system of the invention 100 is activated to perform the subsequent steps S1-S4 to provide on-line purchase order manipulation progress report to the customer 20 (note that the received EDI-850 electronic purchase order is also forwarded to other related departments; but since these procedures are not within the spirit and scope of the invention, description thereof will not be detailed).

In the step S1, the EDI platform 110 receives the EDI-850 electronic purchase order; and then in the next step S2, the received EDI-850 electronic purchase order is forwarded to the progress reporting platform 120.

In the next step S3, the progress reporting platform 120 is used to establish a new purchase order manipulation progress report for the received EDI-850 and then continues to monitor the progress of the purchase order manipulation by the related production and customer service departments, which includes the stages of, for example, purchase order acknowledgement, production scheduling, delivery, customs/exportation, and shipment notification; i.e., at the completion of each stage of the purchase order manipulation, the progress reporting platform 120 is used to record all related data into the purchase order manipulation progress report.

In the next step S4, the progress reporting platform 120 downloads the purchase order manipulation progress report into the Web-linked database 130. Since the Web-linked database 130 is linked to the Web server 140, it allows the customer 20 to promptly receive the purchase order manipulation progress report and view it through a Web browser program, such as Microsoft Internet Explorer or Netscape Navigator.

In conclusion, the invention provides a purchase order tracking system and method, which is characterized by the provision of an on-line purchase order manipulation progress report for each received EDI-850 electronic purchase order to record related data at the completion of each stage of the purchase order manipulation. The purchase order manipulation progress report is then downloaded into a Web-linked database so as to allow the customer to gain access to the purchase order manipulation progress report by linking via Internet to the Web server and view the contents of the purchase order manipulation progress report through a Web browser program. Compared to the prior art, the purchase order tracking system and method of the invention allows the customer to track the progress of the manipulation of the purchase order more efficiently and reliably in real time via Internet. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangement.

What is claimed is:

1. A purchase order tracking method for use by a manufacturer to allow a customer issuing an electronic purchase order to the manufacturer to track the progress of purchase order manipulation by the manufacturer;
the method comprising the steps of:
(a) receiving the electronic purchase order;
(b) establishing a purchase order manipulation progress report for the received electronic purchase order;
(c) recording related data into the purchase order manipulation progress report at the completion of each stage of the progress of purchase order manipulation by the manufacturer; and
(d) downloading the purchase order manipulation progress report into a network-linked database linked to a network server linked to a network system, so as to allow the customer to gain access to the purchase order manipulation progress report by linking via the network system to the network server and view the contents of the purchase order manipulation progress report through a browser program.

2. The purchase order tracking method of claim 1, wherein in said step (a), an EDI platform is used to receive the electronic purchase order.

3. The purchase order tracking method of claim 1, wherein in said step (d), the network system is Internet.

4. The purchase order tracking method of claim 3, wherein in said step (d), the network server is a Web server.

5. The purchase order tracking method of claim 3, wherein in said step (d), the browser program is Microsoft Internet Explorer.

6. The purchase order tracking method of claim 3, wherein in said step (d), the browser program is Netscape Navigator.

7. A purchase order tracking method for use by a manufacturer to allow a customer issuing an electronic purchase order to the manufacturer to track the progress of purchase order manipulation by the manufacturer;
the method comprising the steps of:
(a) receiving the electronic purchase order via an EDI platform;
(b) establishing a purchase order manipulation progress report for the received electronic purchase order;
(c) recording related data into the purchase order manipulation progress report at the completion of each stage of the progress of purchase order manipulation by the manufacturer; and
(d) downloading the purchase order manipulation progress report into a Web-linked database linked to a Web server linked to Internet, so as to allow the customer to gain access to the purchase order manipulation progress report by linking via the Internet to the Web server and view the contents of the purchase order manipulation progress report through a Web browser program.

8. The purchase order tracking method of claim 7, wherein in said step (d), the browser program is Microsoft Internet Explorer.

9. The purchase order tracking method of claim 7, wherein in said step (d), the browser program is Netscape Navigator.

10. A purchase order tracking system for use by a manufacturer to allow a customer issuing an electronic purchase order to the manufacturer to track the progress of purchase order manipulation by the manufacturer;
the system comprising:
an EDI platform for receiving the electronic purchase order from the customer;
a progress reporting platform, which is used to establish a purchase order manipulation progress report for the received electronic purchase order, and which is further used to record related data into the purchase order manipulation progress report at the completion of each stage of the progress of purchase order manipulation;
a Web-linked database, which is used to store the purchase order manipulation progress report downloaded from the progress reporting platform; and
a Web server, which is externally linked to Internet and internally linked to the Web-linked database so as to allow the customer to gain access to the purchase order manipulation progress report by linking via Internet to the Web server and view the contents of the purchase order manipulation progress report through a Web browser program.

11. The purchase order tracking system of claim 10, wherein the Web browser program is Microsoft Internet Explorer.

12. The purchase order tracking system of claim 10, wherein the Web browser program is Netscape Navigator.
